(19) United States
(12) Patent Application Publication
(10) Pub. No.: US 2011/0307373 A1
(43) Pub. Date: Dec. 15, 2011

(54) System and method for Internet based peer-to-peer banking

(76) Inventor: Christian Manuel Chang, Irvine, CA (US)

(21) Appl. No.: 12/714,591

(22) Filed: Mar. 1, 2010

Related U.S. Application Data
(60) Provisional application No. 61/156,448, filed on Feb. 27, 2009.

(51) Int. Cl. G06Q 40/00

(52) U.S. Cl. 705/38

(57) ABSTRACT

A method for providing an Internet based peer-to-peer banking includes: providing a website; lender or borrower defining desired loan terms on the website; website communicating lender's or borrower's loan terms, respectively, to a borrower or lender respectively; the website storing data pertaining to the loan, the borrower, and the lender; the website sending periodic billing statements and reminders to the borrower regarding loan payments to be made and balances; the borrower and the lender choosing to make automatic payments through the website or make loan payments through other means; the borrower and the lender having the ability to report to the website all loan payments that have been made or missed; the website storing data pertaining to all made and missed loan payments; the website providing the record of the loan payments to the borrower and lender upon maturity or default of the loan.

### CROSS REFERENCE TO RELATED CO-PENDING APPLICATIONS

This application claims the benefit of the U.S. Provisional application Ser. No. 61156448 filed on Feb. 27, 2009 and entitled SYSTEM AND METHOD FOR INTERNET BASED PEER-TO-PEER BANKING which is commonly assigned and the contents of which are expressly incorporated herein by reference.

### FIELD OF THE INVENTION

The present invention relates to a system and a method for Internet based peer-to-peer banking. This particular method relies on users having desired loan terms and transmitting them via a website to other users for acceptance or rejection. The website will automate aspects of the loan arrangement after acceptance.

### BACKGROUND OF THE INVENTION

Peer-to-peer is an exciting method of exchanging anything important to people. Be it music, movies, photos, documents and any other sort of data, it can be transferred quickly, efficiently and safely through peer-to-peer sharing. Peer-to-peer banking is an application of peer-to-peer principles to the process of financial loans.

The normal system of borrowing and lending is fraught with rigor, ambiguity, and victimization. The foremost method of borrowing money is through banks and credit cards. These systems of borrowing may require extensive amounts of paperwork, demonstration of prior loan histories, production of employment records and wage history among other requirements. As such the normal process for acquiring a loan can be extremely difficult. Above all of these difficulties a borrower may find the interest rates on their loans are very high. These problems make borrowing from typical institutions a costly option.

As far as lending is concerned there are not many official ways a regular person can participate in lending their own capital for profit. Most methods of lending your own capital for profit are fraught with extensive risk. Offsetting the risk of lending requires notes, well kept records, and reminders to the borrower to repay the loan. Above all of these difficulties a lender may encounter they may not be able to collect sufficient interest on their loans to make lending worth the risk.

This present invention makes several improvements to the process of Internet based peer-to-peer banking. As an example of prior art one may refer to U.S. Pat. No. 1,139,4035, McGowan.

Regarding prior art in the field there are patented inventions and unpatented implementations that realize goals that may appear similar. However their methodologies are substantially different and their end product is different from the final product of this present invention. This present invention accomplishes the goal of facilitating loans between borrower and lender in a novel and different manner than prior art.

Differences between this invention and prior inventions are numerous. Prior inventions sought to create a database of lenders and a database of borrowers prior to the lender and borrower corresponding. Lenders and borrowers would be matched through automated processes, algorithms, or even through competition for loans in the form of auction like bidding. A willing lender and borrower are not sure to find a partner for their transaction.

Prior inventions also demand an abundance of information, prior to a loan and loan terms being agreed upon, from the borrowers and lenders. This information includes home addresses, social security numbers, credit scores, credit history, etc. This collection of information assigned rankings and insured viable and suitable borrowers. This information is a large burden for borrowers to produce, especially for relatively small amounts of money. Sensitive information of this nature also poses a security and liability risk for all the stakeholders.

Prior inventions made use of loan guarantors. The inclusion of loan guarantors generated a need for an abundance of risk calculation, cost-benefit analysis, and a a formidable burden on the part of potential borrowers and lenders to provide their respective background data. Once again this information is burdensome to produce and poses immense security risk for all stakeholders.

### SUMMARY OF THE INVENTION

This present invention provides a system and method for Internet based peer-to-peer banking. This invention provides for a website wherein a user intending to lend/borrow from a person or persons. The term person can be used to refer to individual people as well as business entities such as proprietorships, LLCs, or corporations. The user need only know minimal contact information of the person they intend to borrow from or lend to, such as an e-mail address, address, or phone number. The user may then make a formal invitation to that person to lend/borrow and create a loan arrangement.

The terms of the loan arrangement shall include but are not limited to such terms as are normally components of loans. These loan terms encompass the principal amounts of the loan, the interest rate (annual percentage rate, i.e. A.P.R.), the duration of the loan repayment period, and the final payment amount. A user who intends to lend or borrow but does not have all the terms calculated beforehand may find on the provided website a program or programs, that are part of the website, that calculate the necessary terms of a loan when given some variables of the loan. The website shall be so designed as to allow for easy progression from the calculation of loan terms to composition of an invitation to lend/borrow.

The invitation to lend/borrow shall be an automatically computer generated form. The inviting lender/borrower will provide nominal information so that the invitation may then be sent to the invited borrower/lender. The invitation may be communicated electronically through means such as electronic mail. The invitation will notify a person that they are invited to borrow/lend. The invitation will display the terms of the loan that they are invited to participate in or show the invited borrower/lender the website they must go to in order to find the terms of the loan. The invited borrower/lender may then accept the invitation as an opportunity to borrow/lend at an attractive interest rate and according to the loan terms defined by the inviter. The invitation will explain to the invited the process of accepting the invitation or how to learn more information about the invitation and loan. To accept the invitation to lend/borrow the invited shall access the same provided website as the inviter accessed. At the website the invited user will confirm acceptance of the loan and loan terms. Should the invited wish to reject the offer to lend/borrow the invited may simply ignore the invitation, respond through electronic mail or through the provided website in the negative, and/or correspond to the inviter as to why invitation was rejected. If the loan terms had an error the invited user may send the corrected loan terms to the inviter.

During the process by which a user invites a person to participate in the loan the website shall collect various data pertinent to the loan and users and store it in a storage device for future processing as necessary. At the time that loan terms are agreed upon by the invited user a number of actions shall occur to establish the financial relationship between the borrower and lender. The electronic loan contract will be drafted and signed at this time.

The lender and borrower shall have the opportunity to furnish to the website financial account information. This financial account information, if furnished, shall be sufficient to withdraw money from the borrower's financial accounts and deposit it into the lender's financial accounts. Withdrawals and deposits shall then be done by an automated system that is a component of the website. These withdrawals shall be sufficient to meet the obligation of payment of the loan as dictated by the agreed upon loan terms. Withdrawals from the borrower's account for payment to the lender may be, at the borrower's discretion: automatically executed every payment period; or require the borrower's confirmation every payment period; or be bypassed completely for payment to the lender by a different method. Lenders/borrowers need not provide financial account information to the website but shall provide a minimal amount of information so that the borrower may pay the lender in timely manner.

The payment system component of the website shall record all funds it collects from borrower's financial accounts and all funds it delivers to a lender's financial accounts. When a lender/borrower chooses not to provide financial account information for automated payments then the lender/borrower is required to report to the website all payments made, all late payments and all missed payments.

Through peer-to-peer lending and borrowing, a lender or borrower can gain many benefits similar to the existing system of lending and borrowing while achieving the rates of return or the interest rates that they desire.

### BRIEF DESCRIPTION OF THE DRAWINGS

FIG. 1 is a schematic diagram of an Internet based peer-to-peer banking system.

FIG. 2 is a block diagram of an embodiment of an Internet based peer-to-peer banking system.

### DETAILED DESRCIPTION OF THE INVENTION

The present invention is a system and method for Internet based peer-to-peer banking. This novel Internet based peer-to-peer banking system facilitates lending and borrowing between two persons through the Internet. This present invention provides many benefits over traditional borrowing/lending. Internet based peer-to peer banking holds advantages for borrowers such as: removing traditional lenders and their procedures from the lending process; removing a need for borrower to submit abundant amounts of personal data. Internet based peer-to peer banking allows people an opportunity to lend their money safely and in a way previously unavailable. For example, John Doe wishes to borrow $500 from his cousin, Jane Roe. John Doe and Jane Roe discuss the possible loan and loan terms. After the loan terms are agreed upon Jane Roe wishes to have a formal agreement for the loan and a system for her to recover her money from John Doe. Either John Doe or Jane Roe then enters the Internet based peer-to peer banking website. From the website John Doe or Jane Roe may formalize the loan, create a loan contract, and set up payments according to the agreement they arrived at earlier.

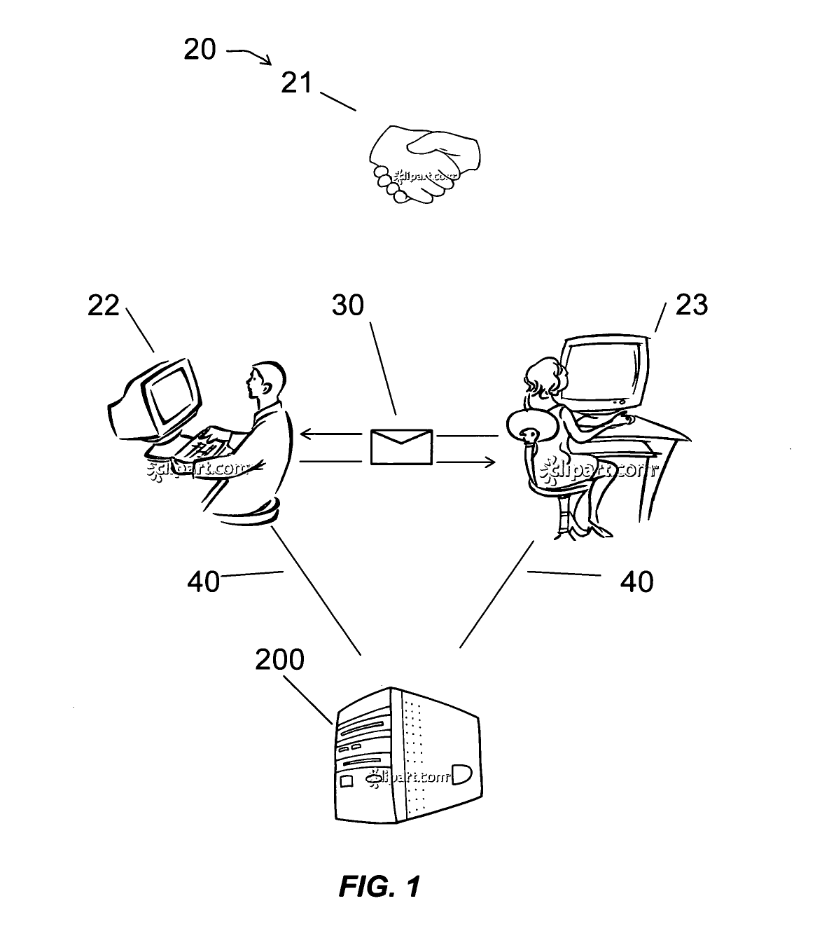

Referring to FIG. 1, in the Internet based peer-to-peer banking system 20, Jane Roe agrees to lend money to John Doe and John Doe agrees to borrow money from Jane Roe in step 21. John Doe 22 accesses the website, henceforth referred to as the “Website” 200, via a network connection 40 and sends the electronic loan invitation 30 to Jane Roe 23. Alternately, instead of John Doe 22, Jane Roe 23 may access the “Website” 200 via a network connection 40 and send the electronic loan invitation 30 to John Doe 22. The user that receives the electronic loan invitation 30 then confirms to the “Website” 200 that the loan is acceptable. The “Website” and it's automated system of components 200 then executes a number of loan management actions including: producing the binding loan contract; submitting billing statements to borrower; may upon request electronically submit payments to lender's financial accounts from borrower's financial accounts; and maintains all payment records of the loan.

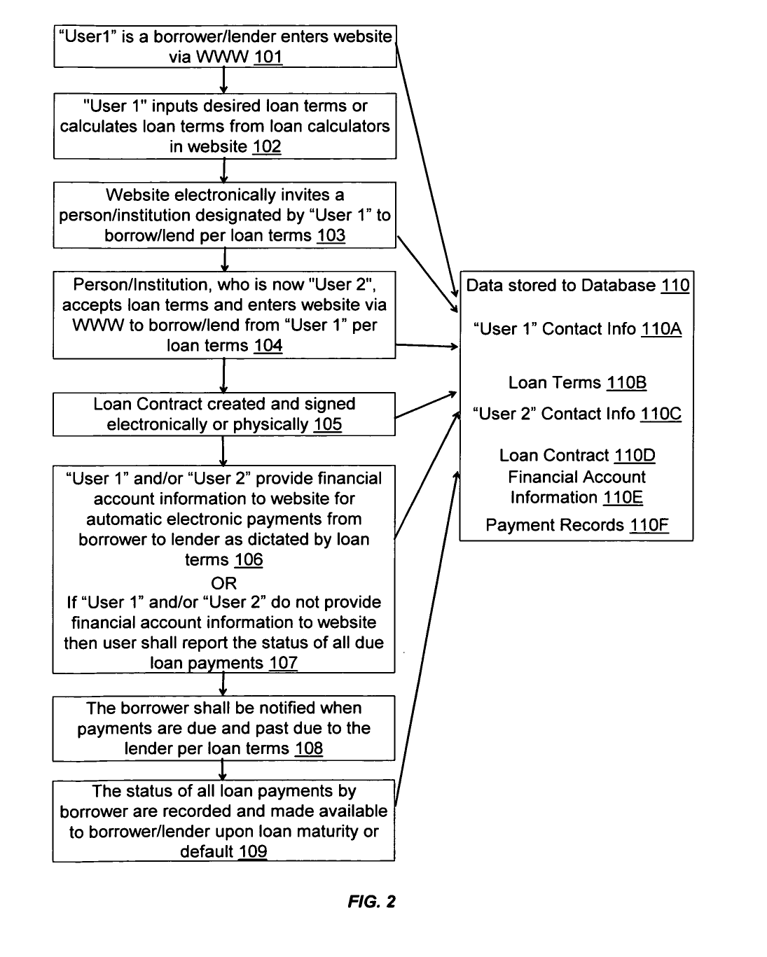

Referring to FIG. 2, a user, henceforth referred to as “User 1” 22, of the Internet based peer-to-peer banking system 20, is a lender or borrower intending to borrow or lend from a different user, henceforth referred to as “User 2” 23. “User 1” 22 enters website “Website” item 200 in step 101. “User 1's” 22 minimum contact information 110A is stored in a data storage device, henceforth referred to as the “Database” 110. The minimum contact information 110A shall be sufficient for a borrower or lender to accept or make a loan payment by means of electronic payments systems such as PayPal™, credit card, debit card, electronic checks, or future electronic payment systems.

“User 1” 22 possesses desired loan terms from prior agreement 21, henceforth referred to as “Loan Terms” item 110B in step 102. If “User 1” 22 is not in possession of the exact “Loan Terms” 110B, “User 1” 22 inputs nominal loan variables into a program, supplied on the “Website” 200, that calculates “User 1's” 22 desired loan terms 102, thus creating the “Loan Terms” 110B.

“User 1” 22 inputs the “Loan Terms” 110B manually or via automated program, supplied on the “Website” 200, into an automated loan invitation item 30 in step 103, henceforth referred to as the “Invitation” 30.

The “Invitation” 30 notifies “User 2” 23, via e-mail or other electronic communication, of the opportunity to borrow/lend from “User 1” 22 according to the “Loan Terms” 110B. At this time the data on the “Loan Terms” 110B is stored to the “Database” 110.

The “Invitation” 30 instructs “User 2” 23 on how to proceed 104 to borrow/lend money according to the “Loan Terms” 110B. “User 2” 23 accepts borrowing/lending according to the “Loan Terms” 110B. “User 2”'s minimum contact information 110C is stored in the “Database” 110.

“User 2” 23 shall confirm to the “Website” 200 of acceptance of the “Loan Terms” item 110B in step 104. “User 2's” 23 acceptance shall be confirmed via electronic communication such as an electronic reply to the “Invitation” 30, or by accessing the “Website” 200 and confirming acceptance of the “Loan Terms” 110B.

“User 1” 22 and “User 2” 23 shall, by electronically or physically signing a loan contract, henceforth referred to as the “Loan Contract” 110D, consent to abide to lend and repay funds to each other according to the “Loan Terms” item 110B in step 105. The “Loan Contract” 110D is legally binding and shall be enforceable in a court of law. The “Loan Contract” 110D shall be stored in the “Database” 110.

A representative of the “Website” 200, henceforth referred to as “Loan Administrator”, shall manage the loan from this point forward in the transaction process. The “Loan Administrator” is a representative of the “Website” 200 and shall be considered a component of the “Website” 200. The “Loan Administrator” 200 may be a real person or a computerized, automated processor of the loan. For example Agent Richard is a “Loan Administrator” 200. Agent Richard is a representative of the “Website” 200 with the proper authority to perform the functions of the “Website” 200 in regards to managing a loan. Agent Richard's task may also be done by an automated program or set of programs, but this program(s) would still be considered to comprise a “Loan Administrator” 200.

At this time “User 1” 22 and “User 2” 23 shall have the option to provide financial account information item 110E in step 106 to the “Loan Administrator” 200. If a borrower provides financial account information 110E, the financial account information 110E shall be sufficient for the “Loan Administrator” 200 to withdraw funds from the borrower's financial accounts automatically, periodically and sufficiently to repay the loan to the lender 106 according to the “Loan Terms” 110B.

If a lender provides financial account information 110E, the financial account information 110E shall be sufficient for the “Loan Administrator” 200 to withdraw funds from the lender's financial accounts automatically, and sufficiently to dispense the original loan amount. The financial account information 110E the lender provides shall also be sufficient for the “Loan Administrator” 200 to deposit the borrower's payments automatically and periodically 106 according to the “Loan Terms” 110B. All financial account information provided 110E shall be stored in the “Database” 110.

If the borrower does not provide financial account information 110E to the “Loan Administrator” 200 then the borrower shall commit to payments to the lender by due dates as agreed upon in the “Loan Terms” 110B. If a borrower and/or lender does not provide financial account information 110E for the purpose of automated payments, that user(s) shall report the status of loan payments to the “Loan Administrator” 200, via means provided electronically or via the “Website” 200 whenever payments are due. The reporting shall occur for the life of the loan until loan maturity or loan default. If the payments are done automatically by the “Loan Administrator” 200 using the borrower's and/or lender's financial account information 110E then the borrower and/or lender does not need to report the status of the loan payments.

The “Loan Administrator” shall provide billing information 108 to “User 1” 22 and “User 2” 23. The borrower, be it “User 1” 22 or “User 2” 23, shall be notified of payment due dates on a periodic basis via electronic communication such as electronic mail or via paper billing 108.

The “Loan Administrator” 200 shall make a complete record, henceforth referred to as “Payment Records” 110F, of the status of all loan payments 109. “Payment Records” 110F shall be made electronically and stored to the “Database” 110 for future use by the “Loan Administrator”. Future use of the “Payment Records” 110F includes making the records available to “User 1” 22 and “User 2” 23 when the loan has matured or defaulted. The recording of loan payments shall occur for the life of the loan until loan maturity or loan default 109.

What is claimed is:

1. A method for providing an internet based peer-to-peer banking service comprising:
providing a website wherein said website is accessible via a network connection and comprises a plurality of interlinked webpages stored in a memory and said memory is couple to a computing circuit and to a communications interface for communicating via said network connection;
creating desired loan terms under which a loan is to be made;
notifying a lender, via an electronic invitation, of a borrower's intention to borrow, or notifying a borrower, via an electronic invitation, of a lender's intention to lend;
creating a binding loan agreement via an automated, interactive loan documenting process.

2. The method of claim 1 further comprising said lender accepting said borrower's said electronic invitation to lend to said borrower, or said borrower accepting said lender's said electronic invitation to borrow from said lender;
said electronic invitation being sent via networked devices.

3. The method of claim 1 wherein said loan terms comprise: total loan amount, loan payments, total loan amount repayed, based on variables which include the amount of loan to be made, the desired repayment interest rate, and the desired length of loan repayment.

4. The method of claim 1 wherein said binding loan agreement between said lender and said borrower is created via an automated process.

5. The method of claim 4 wherein said automated process comprises a said borrower or said lender sending said electronic invitation via the said website to said lender or said borrower;
the recipient of said electronic invitation accepting or rejecting said electronic invitation via the said website;
cancellation of said electronic invitation after a pre-disclosed period of time.

6. The method of claim 1 further comprising collecting information about said borrower and said lender.

7. The method of claim 1 further comprising presenting a contract for said peer-to-peer banking service to said borrower and said lender;
said contract being signed electronically or physically.

8. The method of claim 7 further comprising verifying distribution of funds of said loan to said borrower.

9. The method of claim 8 further comprising collecting funds of said loan from said lender and distributing to said borrower;
said lender and said borrower independently verifying distribution of said funds and providing verification via said website as an alternative to the method of claim 8.

10. The method of claim 8 further comprising keeping track of all financial transactions comprising said collection and distribution of funds, repayment of said funds plus interest from said borrower to said lender, and transaction costs.

11. The method of claim 8 further comprising receiving said funds by said borrower via electronic payment into an electronic account.

12. The method of claim 11 further comprising of said borrower paying back said funds to said lender via electronic payment;
sending notice of due loan payments, via an electronic communication, for the repayment period of said loan;
said lender and said borrower independently verifying repayment of said funds to said lender by said borrower and providing verification via said website as an alternative to the method of claim 11.

13. The method of claim 1 wherein said website comprises a user secure login webpage, a user secure registration webpage, a company information webpage, a user query webpage, a user guidance webpage, and terms of use webpage, as well as webpages necessary to navigate said website.

14. The method of claim 1 wherein said website comprises links to webpages selected from a group consisting of user's account information, all open and closed transactions, programming for calculating loan terms, and programming for sending electronic invitations for loans.

15. The method of claim 14 wherein said programming for calculating loan terms consists of automated loan calculators that compute loan payments, total interest amount repayed and total loan amount repayed, based on variables which include the amount of loan to be made, the desired repayment interest rate, the method that interest on the loan accrues, and the desired length of loan repayment.

16. A system for providing an internet based peer-to-peer banking service comprising:
a website wherein said website is accessible via a network connection and comprises a plurality of interlinked webpages stored in a memory and said memory is couple to a computing circuit and to a communications interface for communicating via said network connection;
means for setting desired loan terms under which a loan is to be made;
means for said lender to invite, via an electronic invitation, a said borrower to borrow a loan for desired amount and said loan terms, or for said borrower to invite, via an electronic invitation, a said lender to lend a loan for desired amount and said loan terms;
means for creating a binding loan agreement via an automated, interactive loan documenting process.

17. The system of claim 16 wherein said loan terms comprise: total loan amount, loan payments, total loan amount repayed, based on variables which include the amount of loan to be made, the desired repayment interest rate, and the desired length of loan repayment.

18. The system of claim 16 wherein said binding loan agreement between said lender and said borrower is created via an automated process.

19. The system of claim 18 further comprising means for said lender or said borrower to make an electronic invitation to lend or borrow;
said electronic invitation being sent via networked devices.
means for said lender or said borrower to accept said electronic invitation;

20. The system of claim 16 further comprising means for collecting information about said lender and said borrower.

21. The system of claim 16 further comprising means of presenting a loan contract to said borrower and said lender;
a means of said contract being signed electronically or physically.

22. The system of claim 21 further comprising means of collecting funds of said loan from said lender and distributing to said borrower;
a means of said lender and said borrower independently verifying distribution of said funds and providing verification via said website as an alternative to the system of claim 21.

23. The system of claim 22 further comprising means for keeping track of all financial transactions comprising said collection and distribution of funds, repayment of said funds plus interest from said borrower to said lender, and transaction costs.

24. The system of claim 23 further comprising means for paying back said funds to said lender by said borrower;
a means of sending notice of due loan payments, via an electronic communication, for the repayment period of said loan;
a means of said lender and said borrower independently verifying repayment of said funds to said lender by said borrower and providing verification via said website as an alternative to the system of claim 23.

25. The system of claim 16 wherein said website comprises a user secure log in webpage, a user secure registration webpage, a company information webpage, a user query webpage, a user guidance webpage, and terms of use webpage, as well as webpages necessary to navigate said website.

26. The system of claim 16 wherein said website comprises links to webpages selected from a group consisting of user's account information, all open and closed transactions, programming for calculating loan terms, and programming for sending electronic invitations for loans.

27. The system of claim 26 wherein said programming for calculating loan terms consists of automated loan calculators that compute loan payments, total interest amount repayed and total loan amount repayed, based on variables which include the amount of loan to be made, the desired repayment interest rate, the method that interest on the loan accrues, and the desired length of loan repayment.

28. The system of claim 16 further comprising all incarnations of said website on all devices that can access networks and internet connected devices.
